(19) United States
(12) Patent Application Publication
(10) Pub. No.: US 2015/0129413 A1
(43) Pub. Date: May 14, 2015

(54) Two-Step Membrane Gas Separation Process

(71) Applicants: Yu Huang, Palo Alto, CA (US); Richard W. Baker, Palo Alto, CA (US)

(72) Inventors: Yu Huang, Palo Alto, CA (US); Richard W. Baker, Palo Alto, CA (US)

(73) Assignee: MEMBRANE TECHNOLOGY AND RESEARCH, INC., Newark, CA (US)

(21) Appl. No.: 14/075,578

(22) Filed: Nov. 8, 2013

(51) Int. Cl. B01D 53/22

(52) U.S. Cl. CPC B01D 53/229; B01D 53/226
USPC 203/39; 95/45; 95/52; 95/50

(57) ABSTRACT

A gas separation process for treating a gas stream containing vapors of condensable components. The process includes two membrane separation steps, the second step using membranes of lower selectivity than the first step. Advantageously, the first membrane separation step may be carried out outside the pressure-ratio-limited region and the second membrane separation step may be carried out within the pressure-ratio-limited region. The second residue stream is a desired product of the process, and the process is particularly useful for applications where the target concentration of component A in this product is low, such as below 1-2 vol %.

### FIELD OF THE INVENTION

The invention relates to membrane-based gas separation processes. In particular, the invention relates to a two-step process for gas and vapor separations.

### BACKGROUND OF THE INVENTION

Gas permeation in dense polymer membrane films can be rationalized using the basic solution-diffusion equation:

$${j}_{A} = \frac{{P}_{A}}{𝓁} ( {p}_{A}^{feed} - {p}_{A}^{permeate} ) \qquad ( 1 )$$

where j_{A} is the molar flux (cm³(STP)/cm²·s) of component A, l is the film thickness, P_{A}^{feed} and P_{A}^{permeate} are the partial vapor pressures of component A on the feed side and permeate side of the membrane, and P_{A} is the permeability to component A of the membrane material, usually expressed in Barrer (where 1 Barrer=1×10⁻¹⁰ cm³(STP)·cm/cm²·s·cmHg).

Rearranging equation 1:

$$\frac{{j}_{A}}{( {p}_{A}^{feed} - {p}_{A}^{permeate} )} = \frac{{P}_{A}}{𝓁} \qquad ( 2 )$$

The expression on the left is the pressure-normalized flux, and is numerically equal to the thickness-normalized permeability, usually referred to as permeance, on the right. Pressure-normalized flux or permeance is usually expressed in gas permeation units or gpu (where 1 gpu=1×10⁻⁶ cm³(STP)/cm²·s·cmHg).

The membrane selectivity, α, for one component over another is expressed as the ratio of the permeabilities (or permeances) of the components. Thus, for two components A and B:

$${α}_{AB} = \frac{{P}_{A} / 𝓁}{{P}_{B} / 𝓁} = \frac{{P}_{A}}{{P}_{B}} \qquad ( 3 )$$

Permeance and selectivity are properties that characterize a membrane, and the quest for membrane materials with improved properties continues. In general, there is a well known trade-off between permeability (or permeance) and selectivity. Materials that exhibit high permeability tend to exhibit low selectivity and vice versa.

Process developers are aware that other factors than permeance and selectivity must be considered when designing membrane gas separation processes that are practical and cost effective.

One factor is the energy that must be supplied to perform the separation. To achieve an adequate transmembrane driving force, it is often necessary to compress the feed stream, to draw a vacuum on the permeate side of the membranes, or both. Thus, operating costs tend to scale with driving force, and commercial gas separation processes are typically limited as much by the economics of operating the pumping equipment as by intrinsic membrane properties.

A related factor is membrane area. In general, a high driving force provides a high transmembrane flux and reduces the amount of membrane area required to process a given flow of feed gas; conversely a low driving force lowers flux and increases the required membrane area, and hence the overall size and capital cost of the separation system.

Yet another factor is the pressure ratio, which is the ratio of the total feed pressure divided by the total permeate pressure. A high pressure ratio can increase the overall separation performance. However, a very low permeate pressure can be undesirable because the lower the permeate pressure, the more recompression will be required to bring the permeate gas to a suitable pressure for recycle or other use. For example, a pressure ratio of 50 would mean that the permeate stream would have to be recompressed 50-fold to be recycled within the process. Furthermore, just as with pressure difference, to achieve a high pressure ratio will demand larger, more powerful pumps and compressors, and thus pressure ratio also tends to be limited by cost considerations.

If the preferentially permeating component is condensable, a reduced pressure on the permeate side may be achieved by cooling the permeate stream, causing at least a portion of the condensable component to liquefy, thereby lowering the pressure on the permeate side. In this case, the lower is the temperature to which the permeate stream is cooled, the lower will be the vapor pressure on the permeate side, and the greater will be the pressure ratio. However, obtaining a very low temperature may itself incur an excessive energy cost, so there will again be practical limits on the pressure ratio.

Many efforts have been made to balance these factors to design useful cost-effective separation processes. Some of these efforts involve the use of multi-stage or multi-step membrane units, or combinations of these. Although the terms are sometimes used interchangeably, multi-stage and multi-step units operate in different ways and produce different results.

In multi-stage units, the permeate stream from the first unit passes as feed to the second unit or stage, and so on if there are more than two stages. Such units are typically used when a high purity permeate product is required.

In a multi-step unit, the residue stream from the first unit passes as feed to the second unit or step, and so on. Such units are typically used when a high purity residue product is required.

Various designs have been proposed to improve the performance of two-step processes or systems. U.S. Pat. No. 5,482,539, to Enerfex, teaches the use of different membranes in each of the two steps, the first step being carried out using a membrane of relatively high permeability (and hence low selectivity) and the second using membranes if relatively low permeability (and hence higher selectivity).

A similar concept for a multi-step cascade of membrane units, with at least one step using membranes of greater selectivity than the previous step, is taught in U.S. Pat. No. 5,383,957, to L'Air Liquide.

Conversely, a two-step process in which membranes of higher selectivity are used in the first step and lower selectivity are used in the second step is shown in FIG. 2 of Japanese Patent Application JPS59207827, to Ube industries.

U.S. Pat. No. 6,830,691, to BP Corporation, and U.S. Pat. No. 8,318,013, to UOP LLC, show combined two-step, two-stage arrangements in which the two steps are of different selectivities. In '013, the residue stream from the second stage is recycled to the front of the process (FIG. 3).

U.S. Pat. No. 5,538,536, to L'Air Liquide, teaches two-step processes using membranes of different selectivity in each step, and recycling the permeate stream from the second step to the feed inlet of the first step (see FIG. 2 or 3). Recycle of the second-step permeate is also shown in U.S. Pat. No. 7,875,758, to L'Air Liquide, which further shows operation of the two steps at different temperatures and pressure ratios.

U.S. Pat. No. 4,180,388, to Monsanto Company, discloses two-step processes operated with a relatively low pressure ratio for the first step and a relatively higher pressure ratio for the second step.

A few patents disclose the separation of vapor mixtures using two-step processes. U.S. Pat. No. 4,405,409, to Tusel et al, teaches a preferred two-step arrangement with a lower selectivity membrane being used in the first step and a higher selectivity membrane being used in the second step (col. 2, lines 32-48). A similar approach is recommended in U.S. Pat. Nos. 8,114,255; 8,128,787; and 8,263,815, all owned or jointly owned by Membrane Technology and Research.

U.S. Pat. No. 8,496,831, to Membrane Technology and Research, shows two-step processes used in conjunction with a stripping or distillation column, with recycle of the permeate from the second step to the feed inlet to the first step (FIG. 7) or to the column (FIG. 6).

Despite all of these improvements, there still remains a need for efficient two-step gas separation processes, and especially for processes applicable to separations where one or more components are vapors.

### SUMMARY OF THE INVENTION

The invention is an integrated two-step membrane gas separation process, that is, a gas separation process in which the residue stream from the first membrane separation step becomes the feed stream to the second step, and the permeate from the second membrane separation step is returned to form part of the feed stream to the front of the process.

The process treats a gaseous stream containing at least two condensable components, designated component A and component B, that are to be separated from each other and optionally another component or components in the stream.

Each separation step operates by maintaining the feed side of the membrane at a higher total pressure than the permeate side, thereby creating a partial pressure difference and hence a transmembrane driving force for each component in each step. In addition to the partial pressure difference, there is also a total pressure ratio maintained across each step.

The gaseous feed stream to be treated is introduced to the feed side of the first step, and flows across the feed side of the first membranes, which are selective in favor of the condensable component or vapor A over at least one other component B in the stream. Components permeate the membrane at different rates, resulting in a permeate stream that is enriched in the condensable component A compared with the feed stream. The permeate stream is withdrawn from the permeate side.

The residue stream from the first step, now containing a lower concentration of vapor A than was in the raw feed stream, is passed as feed to the second membrane separation step and flows across the feed side of the second membranes. In the second step, a reduced pressure on the permeate side of the membranes is preferably obtained by cooling the permeate stream to a temperature at which at least a portion of the condensable component in the second permeate stream will liquefy, thereby lowering the vapor pressure on the permeate side, and providing or augmenting the driving force for transmembrane permeation.

The membranes used in the second step are also selective in favor of component A over component B, but have significantly lower selectivity than the membranes used in the first step. For example, the second selectivity should preferably be a factor of 2, 3, 5 or more times lower than the first selectivity, depending on the availability of membranes having such different properties.

The second residue stream is a desired product of the process, and the process is particularly useful for applications where it is desired to reduce the concentration of component A in this product to a low level, such as below 1-2 vol %. In this case, as explained further in the detail section below, the second membrane separation step will usually be operating at least partially in the pressure-ratio-limited region. We have found that the use of a membrane of substantially lower selectivity in the second step will enable the target reduction of concentration of component A to be reached, in conjunction with large savings in membrane area compared with the case where membranes of the same or higher selectivity are used in the second step.

The process is useful for separating any condensable component from gas and vapor mixtures. Representative condensable components that can be separated include water vapor, alcohol vapors, and vapors of various organic solvents. The remainder of the gas mixture may comprise any component or mix of components, and include both condensable and non-condensable components.

The process is particularly useful for separating mixed condensable components, such as ethanol and water.

The process may be used to treat streams from any source. In some cases the stream may have already been subjected to another treatment step or steps, such as by distillation or stripping. In this case, the second permeate stream may be returned to the feed inlet of the first membrane separation step, or to an upstream step.

In a basic embodiment as applied to the separation of a condensable component or vapor A from another component B of a gas mixture, the process of the invention includes the following steps;
(a) passing the gas mixture to a first membrane separation step equipped with first membranes of selectivity α₁ for component A over component B;
(b) maintaining a first driving force for transmembrane permeation in the first membrane separation step, thereby producing a first residue stream depleted in component A compared with the gas mixture and a first permeate stream enriched in component A compared with the gas mixture;
(c) passing the first residue stream to a second membrane separation step equipped with second separation membranes of selectivity α₂ for component A over component B, where α₁ and α₂ satisfy the relationship α₁>α₂;
(d) maintaining a second driving force for transmembrane permeation in the second membrane separation step, thereby producing a second residue stream further depleted in component A compared with the gas mixture and a second permeate stream; and
(e) returning at least a portion of the second permeate stream for further separation treatment within the process.

In a second representative embodiment including a non-membrane separation step, the process of the invention includes the following steps:
(a) providing a separation column adapted to provide a bottoms stream enriched in component A compared with the gas mixture and an overhead stream depleted in component A compared with the gas mixture;
(b) passing the gas mixture into the separation column;
(c) withdrawing the bottoms stream from the separation column;
(d) withdrawing the overhead stream from the separation column;
(e) passing at least a portion of the overhead stream to a first membrane separation step equipped with first membranes of selectivity α₁ for component A over component B;
(f) maintaining a first driving force for transmembrane permeation in the first membrane separation step, thereby producing a first residue stream depleted in component A compared with the overhead stream and a first permeate stream enriched in component A compared with the overhead stream;
(g) passing the first residue stream to a second membrane separation step equipped with second separation membranes of selectivity α₂ for component A over component B, where α₁ and α₂ satisfy the relationship α₁>α₂;
(h) maintaining a second driving force for transmembrane permeation in the second membrane separation step, thereby producing a second residue stream further depleted in component A compared with the overhead stream and a second permeate stream;
(i) returning at least a portion of the second permeate stream for further separation treatment within the separation column.

### BRIEF DESCRIPTION OF THE DRAWINGS

FIG. 1 is a schematic drawing showing a process flow scheme for a basic embodiment of the invention using two membrane separation steps.

FIG. 2 is a graph that plots permeate concentration against feed concentration of component A for a pressure ratio of 5 and a component A permeance of 1,000 gpu.

FIG. 3 is a graph that plots flux of component A through a membrane against feed concentration for a pressure ratio of 5 and a component A permeance of 1,000 gpu.

FIG. 4 is a schematic drawing showing a process flow scheme for an embodiment of the invention in which the second permeate stream is evaporated and returned to the first membrane separation step.

FIG. 5 is a schematic drawing showing a process flow scheme for an embodiment of the invention that includes treatment of the raw mixture in a separation column upstream of two membrane separation steps.

FIG. 6 is a graph that plots permeate concentration against feed concentration of component A for a pressure ratio of 30 and a component A permeance of 1,000 gpu.

FIG. 7 is a graph that plots flux of component A through a membrane against feed concentration for a pressure ratio of 30 and a component A permeance of 1,000 gpu.

FIG. 8 (not in accordance with the invention) is a schematic drawing showing a process flow scheme for a two-step membrane separation process without recycle of the second permeate stream.

### DETAILED DESCRIPTION OF THE INVENTION

The terms condensable component and vapor are used interchangeably herein and both mean a component that is a liquid at 1 bara and 20° C., but is a gas at the initial operating conditions of the first membrane separation step.

The invention is an integrated two-step membrane gas separation process, that is, a gas separation process in which the residue stream from the first membrane separation step becomes the feed stream to the second step, and the permeate from the second membrane separation step is returned to form part of the feed stream to the front of the process.

The process can be carried out on any mixture that is in the gas phase and that contains at least two condensable vapor components. These components are referred to herein for convenience as components A and B, and it is assumed throughout that the membranes are selective in favor of component A over component B. Representative A and B vapors that may be separated from each other and the gas mixture include, but are not limited to, water, ethanol, iso-propanol and other light alcohols, and organic solvents, such as acetone, paraffins and light aromatic hydrocarbons. In addition to the two condensable components, the gas mixture may comprise any component or mix of components, typically including small amounts of non-condensable components such as permanent gases. Non-limiting examples of mixtures to be separated include mixtures of an organic vapor and water, such as ethanol/water, and mixtures of two or more organic compounds.

Typically, but not necessarily, component A is a minor component of the gas or vapor mixture to be treated, by which we mean it is present in a concentration less than 50 vol %. Often the concentration will be lower, such as below 30 vol %, below 25 vol %, or below 20 vol %.

The second residue stream is usually, but not necessarily, the primary product of the process. The process is particularly useful for applications where it is desired to reduce the concentration of component A in this product to a low level, such as below 5 vol %, below 3 vol %, below 2 vol % or even below 1 vol %.

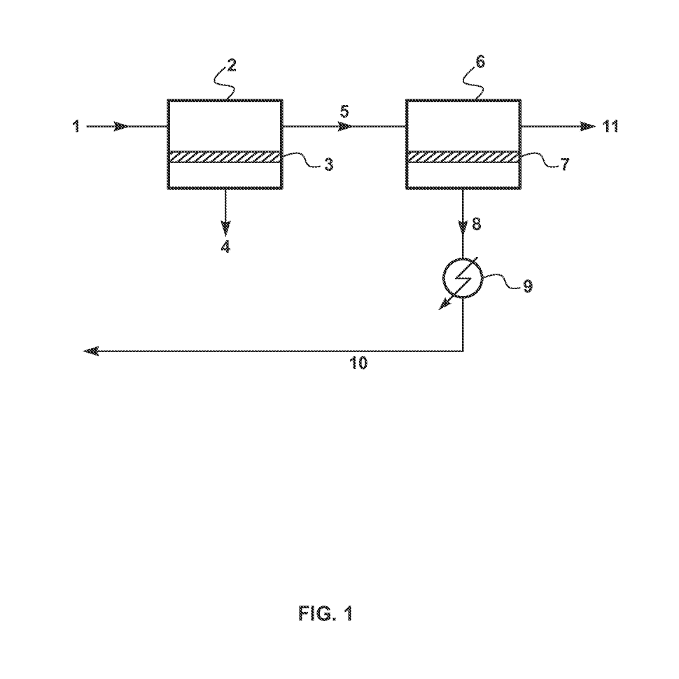

A basic, non-limiting embodiment of the invention is shown in FIG. 1. It will be appreciated by those of skill in the art that this figure and the other process flow schemes herein are very simple schematic diagrams, intended to make clear the key aspects of the invention, and that an actual process train will usually include many additional components of a standard type, such as heaters, chillers, condensers, pumps, blowers, other types of separation and/or fractionation equipment, valves, switches, controllers, pressure-, temperature, level- and flow-measuring devices and the like.

Turning now to FIG. 1, stream 1 is the gaseous feed stream to be treated and contains at least first vapor component A and second vapor component B. If it is desired to treat a stream that originates as a liquid, the stream may be heated upstream of the process to evaporate at least a portion of the stream contents and thereby create gaseous stream 1.

Stream 1 passes into the first membrane separation step, 2, and flows across the feed side of membrane, 3, which has a selectivity for component A over component B of α₁. The selectivity will depend on the materials to be separated. For example, most polymeric membranes are readily permeable to water vapor, and many have high selectivity for water vapor over other gases and vapors.

Examples of membranes that have high selectivity for water vapor over other vapors and gases and that are useful in the first separation step include those with hydrophilic selective layers. Representative hydrophilic selective layers include, but are not limited to, crosslinked polyvinyl alcohol and copolymers thereof, chitosan and its derivatives, cellulose based materials, and Nafion® membranes and like polyelectrolyte membranes. Such hydrophilic membranes may have selectivity for water over other gases or vapors of as much as 200 or more.

Examples of membranes that have high selectivity in favor of one organic vapor over another include, but are not limited to, polar rubbery polymers, such as polyamide-polyether block copolymers (sold under the trade name Pebax® and available from Arkema, Inc., King of Prussia, Pa.). Such copolymers can be used as selective layers for membranes to separate light alcohols and other small polar components from non-polar vapors of aromatic and aliphatic compounds. For separating non-polar vapors from one another, such as benzene, toluene, xylene or other aromatics from C₅₊ paraffins or other aliphatics, suitable selective materials include polyurethane-polyimide block copolymers.

The membranes, 3, may be of any form usable for gas separation, but are usually polymeric membranes with a rubbery selective layer or polymeric membranes with a glassy selective layer. Preferably, the membranes are formed as hollow fibers or flat sheets, both of which forms are well known in the art. The membranes are usually packaged into membrane elements or modules. If the membranes are flat sheet membranes, they are preferably packaged into spiral-wound modules. The first separation unit may contain a single module or a plurality of modules.

Even if they are available, it is preferred not to use membranes of exceedingly high selectivity, such as greater than about 500, as they may result in lower transmembrane fluxes when operating in the pressure-ratio-limited region, as explained below.

The driving force for transmembrane permeation of a component is the difference between the partial or vapor pressure of that component on the feed and permeate sides of the membrane. This pressure difference can be generated in a variety of ways, for example, by compressing the feed stream and/or maintaining lower pressure or a partial vacuum on the permeate side.

Because both components A and B are vapors, the considerations with respect to operating conditions of the process are necessarily different from the considerations that govern separations of non-condensable gases. In such processes, the driving force is normally created by pressurizing the feed gas to a pressure in the range of 10-40 bar or more, and maintaining the permeate pressure at atmospheric pressure or slightly above, such as in the range 1-5 bar.

In vapor separations, it is extremely difficult and impractical to operate at high feed side pressures, as raising the pressure will induce condensation of the components, unless the gas is also heated to very high temperature. For example, a component that boils at atmospheric pressure at 60-100° C. must be heated to a temperature in the range 120-150° C. or above if it is to remain fully in the vapor phase when compressed, even to a relatively modest pressure of 2-5 bar. Many polymeric materials and membranes, as well as other module components, are not stable at such temperatures, so there is an upper limit on the feed temperature and hence pressure that is set by the thermal degradation of the components of the membrane unit.

As the feed pressure is constrained by membrane stability, it is beneficial to operate vapor separation processes under vacuum on the permeate side. This may be accomplished by means of an optional vacuum pump. Since components A and B are condensable, however, an optional, convenient way to lower the pressure on the permeate side is to cool the permeate stream to a temperature at which at least a portion of the permeate stream condenses, generating a spontaneous reduced pressure on that side.

The degree of vacuum achieved is determined by the temperature of the condenser and the vapor pressure of the permeate mixture. In general, it is preferred to operate the condenser at a temperature no lower than 0° C., especially if there is water in the permeate mixture. For some separations, simple water cooling, such as to 25-35° C. may suffice. Condensation at above 0° C. produces a typical permeate pressure between about 0.3 and 0.05 bar, which is adequate for separation of most commonly encountered vapor mixtures.

If any non-condensable gases are present in the permeate stream, a small ancillary pump may be used to remove them.

In addition to the partial pressure differences discussed above, there is a pressure ratio between the feed and permeate sides of the membrane step. The pressure ratio for the first membrane separation step is defined as θ₁, thus

$${θ}_{1} = \frac{{p}_{1}^{feed}}{{p}_{1}^{permeate}} \qquad ( 4 )$$

where p₁^{feed} is the total pressure on the feed side and p₁^{permeate} is the total pressure on the permeate side. As mentioned above, a high pressure ratio may improve the separation performance of the process, but at the expense of greater energy to produce the high ratio.

The enrichment, E, of a component provided by a membrane separation operation is expressed as the ratio of the concentration C of that component on the permeate and feed sides. Thus, for component A, the enrichment E₁ in the first membrane separation step is given by

E₁=C_{A}^{permeate}/C_{A}^{feed} (5)

where C_{A}^{permeate} is the concentration of component A on the permeate side and C_{A}^{feed} is the concentration of component A on the feed side.

For component A to flow from the feed to permeate side, the partial pressure of A in the permeate must remain lower than the partial pressure of A in the feed, thus:

p₁^{permeate}×C_{A}^{permeate}≦p₁^{feed}×C_{A}^{feed} (6)

### Rearranging

$$\begin{matrix}\frac{{C}_{A}^{permeate}}{{C}_{A}^{feed}} \leq \frac{{p}_{1}^{feed}}{{p}_{1}^{permeate}} \\ or & ( 7 ) \\ {E}_{1} \leq {θ}_{1} & ( 8 )\end{matrix}$$

Thus, the enrichment is always numerically less than the pressure ratio, and

C_{A}^{permeate}≦C_{A}^{feed}×θ₁ (9)

In principle, with an infinitely selective membrane, the permeate concentration of A could reach 100%, but the permeate concentration in practice is limited by expression (9). With a pressure ratio of 5 and a feed concentration of 10 vol %, for example, the maximum permeate concentration, irrespective of membrane selectivity, is 50 vol %. Likewise, with a pressure ratio of 30 and a feed concentration of 3 vol %, the permeate concentration can never exceed 90 vol %.

We have found that it is useful to define the feed concentration at which the membrane separation step could in principle produce a permeate containing 100 vol % component A as the limiting concentration. Further, we have recognized that the relationships above can be examined quantitatively by performing computer simulations of the type demonstrated in Examples 1-2 below, and that the limiting concentration can be used to define regions of operation that we refer to as pressure-ratio-limited or non pressure-ratio-limited.

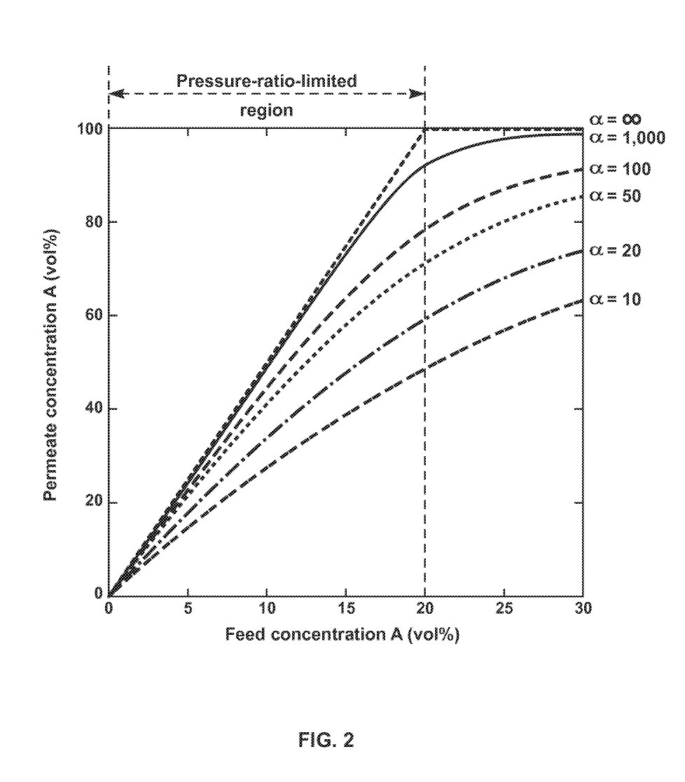

A representative simulation is shown in FIG. 2 for a case assuming a pressure ratio of 5, and a permeance of 1,000 gpu for component A. The figure plots permeate concentration C_{A}^{permeate} against feed concentration C_{A}^{feed}.

Referring to this figure, if the feed concentration of component A is below the limiting concentration of 20 vol %, the permeate concentration cannot reach 100 vol % under any circumstances, and we define the region of the graph to the left of the limiting concentration as the pressure-ratio-limited region. Within this region, as the feed concentration drops towards zero, the separation becomes increasingly pressure-ratio-limited. That is, the benefit of high membrane selectivity is progressively reduced, such that there is progressively less improvement in permeate concentration achieved with a membrane of selectivity of 100 or even 1,000, as compared with a membrane of selectivity 10.

The region to the right of the limiting concentration of 20 vol % is the non pressure-ratio-limited region. In this region, the lines representing the enrichment achieved with membranes of different selectivity are well spaced apart, and a much better result, at least in terms of permeate concentration, can be obtained if a membrane of high selectivity is available.

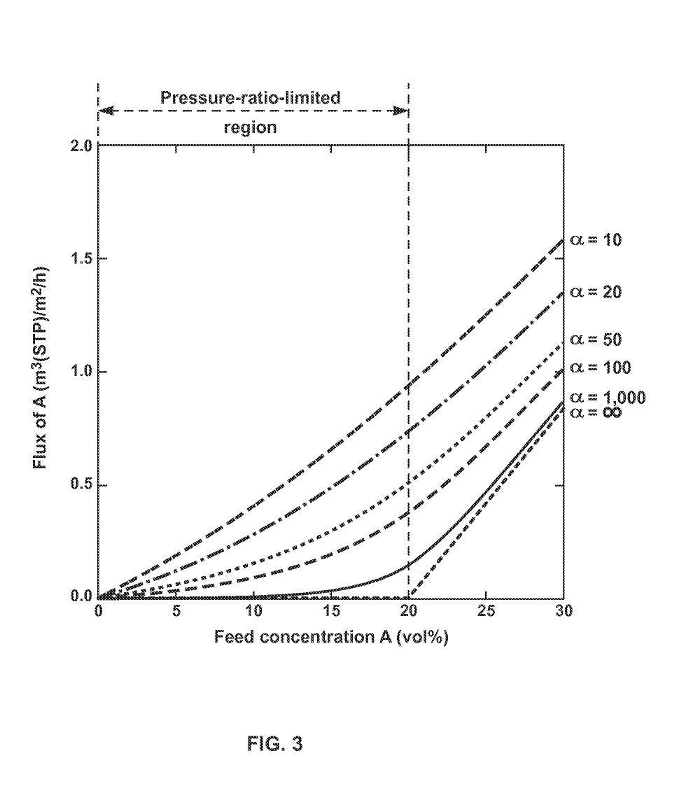

The flux of component A through the membrane is also affected by operating within or outside the defined pressure-ratio-limited region. We have further recognized that this relationship can be examined quantitatively, as in FIG. 3, which shows results based on the same assumptions as for FIG. 2.

All the membranes are assumed to have the same permeance of 1,000 gpu for component A, but the actual flux of material through the membrane that can be obtained is different at different selectivities. The membrane with the lowest selectivity has the highest flux of component A. Membranes with higher selectivities have lower component A fluxes, despite the fact that the permeance is unchanged.

The decrease in flux with increasing selectivity is a result of the need to permeate the slower permeating component or components, since the permeate cannot be composed 100% of component A. This effect is aggravated in the pressure-ratio-limited region. Below the feed gas 20 vol % limit, FIG. 3 shows that a membrane with extremely high selectivity, above about 500, has almost no flux.

FIGS. 2 and 3 were plotted assuming a pressure ratio of 5 and a component A permeance of 1,000 gpu. In light of these teachings, it will be apparent to those of skill in the art that graphs of the type shown in FIGS. 2 and 3 can be plotted for other pressure ratios and permeances, and that the specific numerical values for permeate concentration and transmembrane flux, and the extent of the pressure-ratio-limited and non pressure-ratio-limited regions, will differ depending on the starting assumptions.

What can be appreciated from plots of the type of FIGS. 2 and 3 is that operation of the first membrane separation step outside the pressure-ratio-limited region is beneficial in terms of achieving both a good separation and a high transmembrane flux.

It is preferred, but not required, therefore, that the first membrane separation step operate, at least predominantly, outside the pressure-ratio-limited region.

Expressed in numerical terms, it is preferred that the pressure ratio θ₁ be at least 5, more preferably at least 10 and most preferably at least 15 or 20. Expressed as a range, it is preferred that the pressure ratio be in the range 5-60, more preferably 10-50 and most preferably 20-50.

Referring again to FIG. 1, the first membrane separation step yields a permeate stream, 4, enriched in component A compared with stream 1, that may be sent to any destination in gas or condensate form. If it is desired to enrich stream 4 further in component A, for example, it may be sent to a second membrane separation stage.

This step also yields a residue stream, 5, which is depleted in component A compared with stream 1. For example, the content of component A in stream 5 may be three-, four- or five-fold lower than the content of component A in stream 1.

Stream 5 passes as a second feed stream to the second membrane separation step, 6. Expressions of the same type as expressions (4)-(8) are equally valid for the second membrane separation step. Thus, if θ₂ is the pressure ratio for this step and E₂ is the enrichment of component A in this step, then:

E₂≦θ₂ (10)

and there will again be a limiting concentration for this step based on the feed concentration to this step (the concentration of component A in stream 5) and the pressure ratio θ₂.

The modules of this second membrane separation step 6 contain membranes, 7, that have selectivity for component A over component B of α₂. The concentration of component A in stream 5 has already been substantially reduced by first membrane separation step, 2, and is likely to be low, such as below 10 vol % or below 5 vol %, for example.

As was seen from FIGS. 2 and 3, the lower the feed concentration, the more likely is the separation to be pressure-ratio limited. Thus the separation that occurs in the second step will often be carried out mostly or entirely in the pressure-ratio-limited region. As such, the selectivity α₂ should be lower, and preferably much lower, than α₁ to avoid severe reductions in transmembrane flux. By much lower, we mean that the ratio α₁/α₂ should be at least 2, more preferably at least 3 and most preferably at least 5 or even 10.

Expressed numerically, therefore, α₂ should be below 100, and more preferably below 50.

As one option, the membranes of the second membrane separation step can be made from the same base materials as the membranes for the first membrane separation step, but prepared in a different way.

More preferably, different polymers may be used to form the membranes of the two steps. For example, cellulose triacetate membranes may be used in the first step and cellulose diacetate membranes in the second step for separation of methanol from isobutene/MTBE (methyl tert-butyl ether) mixtures. For dehydration of organic mixtures, hydrophilic materials as mentioned above may be used in the first step, and more hydrophobic perfluoro-based materials, such as those described in U.S. Pat. Nos. 8,002,874 and 8,496,831, for the second step. For other organic/organic separations, such as separation of aromatic from aliphatic compounds, representative membranes for this step include those based on polyimides or polyamides.

Stream 5 may be passed directly to step 6 without temperature or pressure adjustment, or may be adjusted as desired to favor operation of step 6. Irrespective of the pressure or temperature of stream 5, at least a part of the driving force for transmembrane permeation in step 6 is provided by cooling the permeate stream, 8, as indicated by step 9. The stream is cooled to a temperature at which at least partial condensation of stream 8 occurs, thereby lowering the pressure on the permeate side of membranes 7. Any means of effecting the cooling can be used, including heat exchange against cooling water, air or other process streams.

The pressure ratio for the second membrane separation step, θ₂, may be the same or different from θ₁ and the same numerical preferences apply for both pressure ratios.

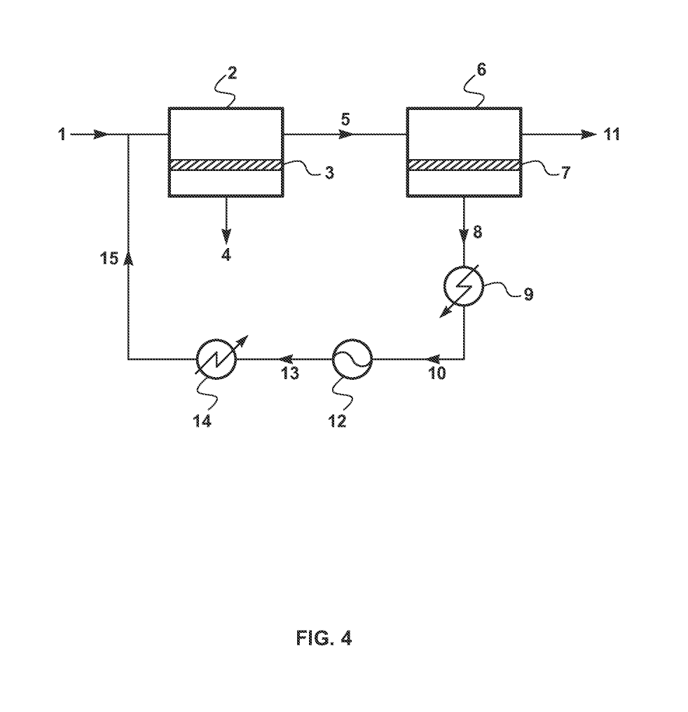

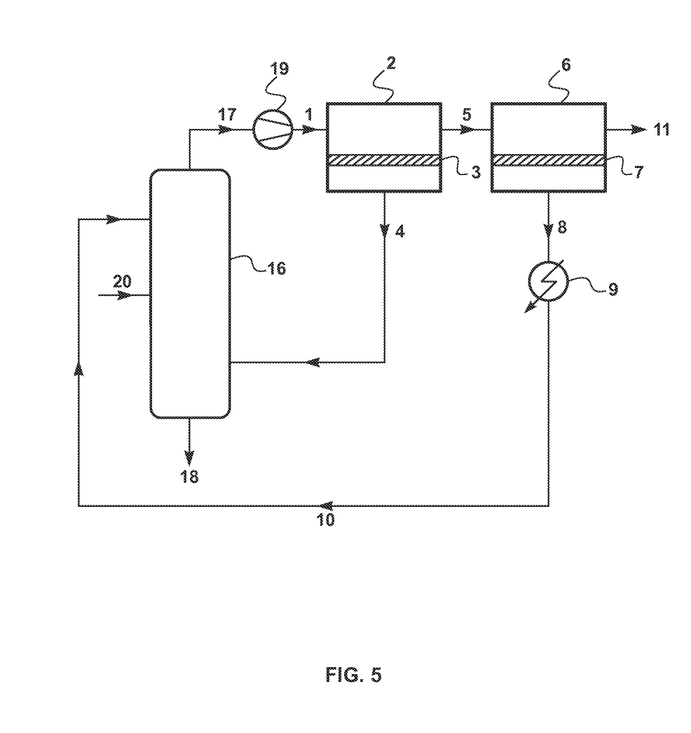

Stream 10, which is wholly or partially in the liquid phase, is withdrawn from step 6 and returned for further treatment within the process or to an upstream operation that produces stream 1. Stream 10 may be returned as a liquid, as a two-phase liquid-gas mixture, or may be heated to return all components to the vapor phase and returned as a gas. Various representative, non-limiting options for returning stream 10 are shown in FIGS. 4 and 5, discussed below.

The principal product stream from the process is typically the second residue stream, 11. The concentration of component A in this stream is much lower than that in stream 1, and is preferably below 5 vol %, and most preferably below 2 vol % or even 1 vol %.

Considering the process of FIG. 1 as a whole, the gas under treatment on the feed side of the membranes of steps 2 and 6 becomes increasingly depleted in component A until it reaches the chosen low target concentration for product stream 11. The initial feed concentration at the inlet end of the first step may be high enough that a pressure ratio can be provided to start the separation outside the pressure-ratio-limited region. However, unless the target concentration of A in the second residue stream is fairly high, such as above about 3 or 4 vol %, there will generally come a point at which the limiting concentration is reached and the separation starts to be pressure-ratio-limited.

Depending on the preferences or requirements for the two permeate streams, 4 and 8, there is some choice as to the point at which the first membrane separation step is terminated and the residue gas mixture emerging from that step is directed as feed stream to the second membrane separation step. Insofar as it does not adversely impact other aspects of the process, for example obtaining a desired enrichment of component A in stream 4, we prefer to terminate the first step at about the point at which the process begins to be pressure-ratio-limited, that is when the concentration of component A in the feed-side gas mixture has dropped to about the limiting concentration for that separation.

This means that, preferably, the first membrane separation step will operate at least predominantly outside the pressure-ratio-controlled region and the second membrane separation step will operate at least predominantly within the pressure-ratio-controlled region.

To avoid confusion, by predominantly, we mean, for the first step, that the residue concentration of component A leaving the first step is no more than 30% lower than the limiting concentration. For example, if the limiting concentration is 8 vol %, the residue concentration for the first step should preferably be no lower than 5.6 vol %. Similarly, if the limiting concentration is 3 vol %, the residue concentration for the first step should preferably be no lower than 2.1 vol %.

Most preferably, the residue concentration of component A leaving the first step is no more than 15% lower than the limiting concentration. In this case, if the limiting concentration is 8 vol %, the residue concentration for the first step should preferably be no lower than 6.8 vol %. Similarly, if the limiting concentration is 3 vol %, the residue concentration for the first step should preferably be no lower than 2.5 vol %.

By similar reasoning, for the second step, predominantly means that the feed concentration of component A entering the second step is no more than 30% higher than the limiting concentration. Using the same examples as above, if the limiting concentration is 8 vol %, the feed concentration entering the second step should be no higher than 10.4 vol %, and if the limiting concentration is 3 vol %, the concentration of the gas mixture entering the second step should be no higher than 3.9 vol %.

Most preferably, the feed concentration of component A entering the second step is no more than 15% higher than the limiting concentration. Thus, if the limiting concentration is 8 vol %, the feed concentration entering the second step should be no higher than 9.2 vol %, and if the limiting concentration is 3 vol %, the concentration of the gas mixture entering the second step should be no higher than 3.5 vol %.

A preferred embodiment of the process of the invention in which the second permeate stream is recycled to the inlet of the first membrane separation step is shown in FIG. 4. In this figure, like elements are labeled as in FIG. 1, and preferences and limitations for the process conditions are the same as for the embodiment of FIG. 1 unless specified otherwise hereafter. In particular, it is preferred that the first step be terminated and the second step be started when the concentration of component A on the feed side is within plus or minus 15% of the limiting concentration.

Referring to FIG. 4, stream 1 passes into the first membrane separation step, 2, and flows across the feed side of membranes, 3, where it is separated into component-A-enriched permeate stream, 4, and component-A-depleted residue stream, 5. Stream 5 passes as feed to second membrane separation step, 6, and flows across the feed side of membranes, 7, where it is separated into product residue stream, 11, and second permeate stream, 8. A low pressure is maintained on the permeate side of membranes 7 by cooling stream 8 by heat exchange or the like in cooling step, 9.

Cooled stream 10, in the form of a full or partial condensate, is pumped under pressure through pump, 12, and passes as pressurized stream, 13, to heater, 14, to be evaporated and returned as a gas stream, 15, to the front of the process, where it forms a portion of the inlet stream to first membrane separation step 2. Step 12 preferably subjects stream 10 to substantially the same pressure as stream 1, so that stream 15 may be mixed with stream 1 or otherwise reintroduced to the process without further pressure adjustment. Step 14 may be carried out by any form of direct or indirect heating that is sufficient to evaporate stream 13.

A preferred embodiment of the process of the invention in which the second permeate stream is recycled to a separation step that is upstream of the two membrane separation steps is shown in FIG. 5. Once again, like elements are labeled as in FIG. 1, and preferences and limitations for the process conditions are the same as for the embodiment of FIG. 1 unless specified otherwise hereafter. In particular, it is again preferred that the first membrane separation step be terminated and the second membrane separation step be started when the concentration of component A on the feed side is within plus or minus 15% of the limiting concentration.

Referring to FIG. 5, the raw feed stream to be treated is stream 20, which once again contains at least two components, A and B, to be separated. In this embodiment, stream 20 may optionally be in the liquid phase when it enters the column, 16.

The separation performed in column 16 may be scrubbing, stripping or distillation, for example, and maybe carried out by standard operations familiar in the chemical engineering arts. In this embodiment, component A typically has a higher boiling point than component B, such that bottoms stream, 18, is enriched in component A, and overhead vapor stream, 17, is depleted in component A. Vapor stream 17 is compressed in compression step 19, and the resulting compressed vapor stream forms the feed stream, 1, to the first membrane separation step, 2.

In step 2, a driving force for transmembrane permeation is provided by compressing stream 17 in compression step or unit, 19, typically to a pressure a few bar, such as 1-10 bar, higher than the pressure at which column 16 is operated. Stream 1 passes into the first membrane separation step, 2, and flows across the feed side of membranes, 3, where it is separated into component-A-enriched permeate stream, 4, and component-A-depleted residue stream, 5. In this representative embodiment, stream 4 may conveniently, although not necessarily, be returned in vapor form to a suitable point in the column, as shown.

Stream 5 passes as feed to second membrane separation step, 6, and flows across the feed side of membranes, 7, where it is separated into product residue stream, 11, and second permeate stream, 8. A low pressure is maintained on the permeate side of membranes 7 by cooling stream 8 by heat exchange or the like in cooling step, 9.

Cooled stream 10 may then be returned, preferably without further pressure or temperature adjustment, to column 16. When operated in the preferred manner shown, the process produces only two streams, the second residue product, now thrice depleted in component A compared with raw feed stream 20, and the component-A-rich stream 18. Embodiments of this type are well suited for dehydration of organic streams, such as those containing light solvents. In this case, stream 18 is essentially a water stream and stream 11 is a dehydrated organic stream, which may as much as 95+vol %, 98+vol % or 99+vol % organic.

The invention is now further described by the following examples, which are intended to be illustrative of the invention, but are not intended to limit the scope or underlying principles in any way.

### EXAMPLES

### Example 1

### Determination of Component A Permeate Concentration Achievable for a Membrane Separation Step Operated at a Pressure Ratio of 30

A series of calculations was performed to determine the permeate concentration of a preferentially permeating component A that can be obtained from a gas mixture of component A with one or more other components B in a membrane separation step, under a given set of conditions. The following assumptions were made:

Pressure ratio: 30 (Feed side 3 bar, permeate side 0.1 bar)
Membrane permeance for component A: 1,000 gpu
Feed concentration of component A: variable
Membrane selectivity for A over B: variable.

The calculations were performed using differential element membrane code written at MTR and incorporated into a computer process simulation program (ChemCad 6.3, ChemStations, Austin, Tex.).

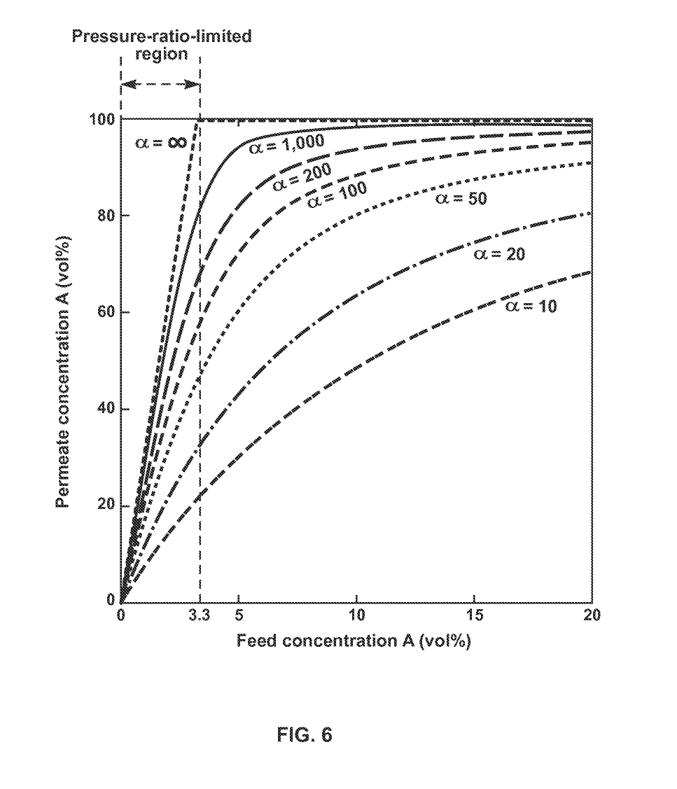

Based on expression (9), with a pressure ratio of 30, the limiting concentration of component A is 3.3 vol %. The results of the calculations for different feed concentrations of component A and for different selectivities are shown in FIG. 6.

As can be seen, when the feed concentration of component A is higher than the limiting concentration and the separation is outside the pressure-ratio-controlled region, the enrichment of component A improves substantially with increasing selectivity. In a practical application, therefore, if permeate concentration were the paramount concern, the membranes with the highest possible selectivity, such as above 200, if such membranes were available, would be indicated for this step. Conversely, below the limiting concentration, relatively modest improvements in permeate concentration are achievable as the selectivity increases.

### Example 2

### Determination of Component A Flux Achievable for a Membrane Separation Step Operated at a Pressure Ratio of 30

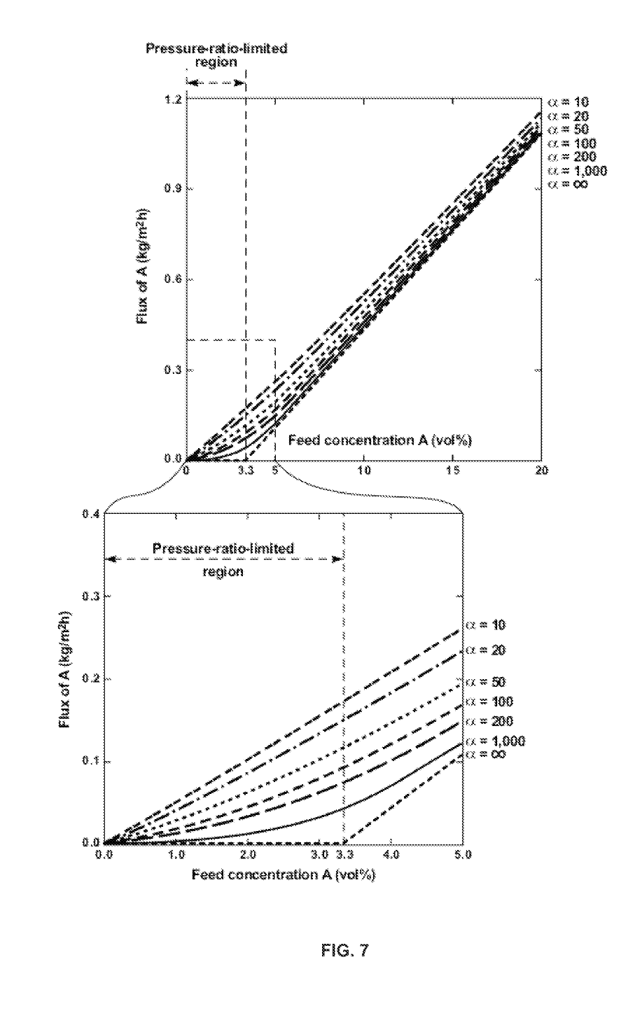

The calculations of Example 1 were repeated, using the same assumptions but this time plotting the flux of component A through the membranes under varying conditions of feed concentration and selectivity. The results are shown in FIG. 7.

At feed concentrations below the limiting value of 3.3 vol %, the separation is in the pressure-ratio-limited region and the component A fluxes are considerably affected by membrane selectivity. In this range, membranes with selectivity above 100 have low component A fluxes, which would necessitate the use of large membrane areas for that step.

Reviewing FIGS. 6 and 7 together, in the pressure-ratio-limited region, the modestly higher enrichment obtained with high selectivity membranes must be traded against the increased cost for a greater membrane area. In this range, membranes with lower selectivities, such as between 20 and 100, are preferred if available.

In the non pressure-ratio-limited region, there is a less pronounced effect of selectivity on flux, and a higher selectivity membrane, such as one having a selectivity between about 100 and 200 or even 300 is preferred if possible. Even outside the pressure-ratio-limited region, however, use of membranes of excessively high selectivity in a membrane separation step may result in undesirably reduced flux in that step.

### Example 3

### Two-Step Process not in Accordance with the Invention, Using Membranes of Like Higher Selectivity

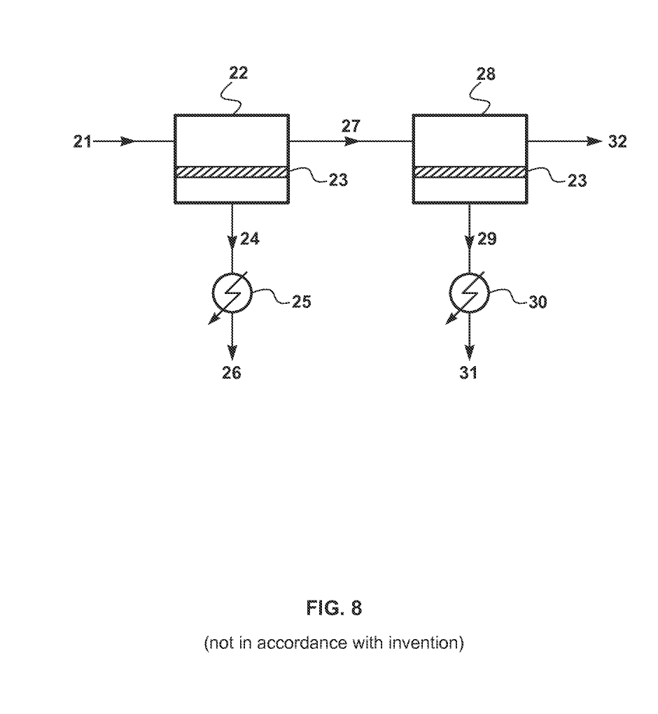

A calculation was performed to model the performance of the two-step membrane separation process of FIG. 8. This process is not in accordance with the invention, because there is no recycle of the second permeate stream, 31, and because we assumed the use of membranes, 23, of the same selectivity of 200 for component A over component B in both membrane separation steps, 22 and 28.

Referring to FIG. 8, raw feed stream, 21, containing at least components A and B, passes into first membrane separation step, 22, flows across the feed side of membranes, 23, and is separated into component-A-enriched permeate stream, 24, and component-A-depleted residue stream, 27. A low pressure is maintained on the permeate side of membranes 23 by cooling stream 24 by heat exchange or the like in cooling step, 25 to produce condensed permeate stream, 26.

Stream 27 passes as feed to second membrane separation step, 28, which contains membranes of the same selectivity as the first step. Stream 27 is separated into product residue stream, 32, and second permeate stream, 29. Stream 29 is cooled in step 30 to produce condensate stream, 31.

The calculations were again performed using differential element membrane code written at MTR and incorporated into ChemCad 6.3. The permeance of the membranes for component A was assumed to be 1,000 gpu and the pressure ratio was set to 30 (3 bar feed, 0.1 bar permeate). The results of the calculations are shown in Table 1.

TABLE 1

| Stream | 21 | 26 | 27 | 31 | 32 |
|---|---|---|---|---|---|
| Total flow (kg/h) | 1,000 | 72 | 928 | 44.0 | 884 |
| Component A con- | 16.0 | 90.8 | 3.3 | 42.0 | 0.76 |
| centration (vol %) | | | | | |
| Temperature (° C.) | 110 | 32 | 110 | 27 | 110 |
| Pressure (bara) | 3 | 0.1 | 3 | 0.1 | 3 |

The process was configured to obtain a first residue/second feed concentration of the limiting concentration of 3.3 vol %. On this basis, a membrane area of 195 m² is needed for the first membrane separation step and a membrane area of 430 m² is needed for the second membrane separation step.

### Example 4

### Two-Step Process not in Accordance with the Invention, Using Membranes of Like Lower Selectivity

The calculation of Example 3 was repeated, this time using a lower selectivity of 20 for both membrane separation steps. Other parameters were the same as in Example 3. The results of the calculation are shown in Table 2.

TABLE 2

| Stream | 21 | 26 | 27 | 31 | 32 |
|---|---|---|---|---|---|
| Total flow (kg/h) | 1,000 | 163 | 836 | 105 | 731 |
| Component A con- | 16.0 | 58.5 | 3.3 | 19.0 | 0.76 |
| centration (vol %) | | | | | |
| Temperature (° C.) | 110 | 29 | 110 | 26 | 110 |
| Pressure (bara) | 3 | 0.1 | 3 | 0.1 | 3 |

The process was again configured to obtain a first residue/second feed concentration of the limiting concentration of 3.3 vol %. On this basis, a membrane area of 140 m² is needed for the first membrane separation step and a membrane area of 120 m² is needed for the second membrane separation step.

### Example 5

### Two-Step Process not in Accordance with the Invention, Using Membranes of Lower Selectivity for the First Membrane Separation Step and Higher Selectivity for the Second Membrane Separation Step

The calculation of Example 3 was repeated, this time using a lower selectivity of 20 for the first membrane separation step and a membrane of higher selectivity of 200 for the second membrane separation step. Other parameters were the same as in Example 3. The results of the calculation are shown in Table 3.

TABLE 3

| Stream | 21 | 26 | 27 | 31 | 32 |
|---|---|---|---|---|---|
| Total flow (kg/h) | 1,000 | 164 | 836 | 40.0 | 797 |
| Component A con- | 16.0 | 58.6 | 3.3 | 41.5 | 0.76 |
| centration (vol %) | | | | | |
| Temperature (° C.) | 110 | 29 | 109 | 29 | 109 |
| Pressure (bara) | 3 | 0.1 | 3 | 0.1 | 3 |

The process was again configured to obtain a first residue/second feed concentration of the limiting concentration of 3.3 vol %. On this basis, a membrane area of 140 m² is needed for the first membrane separation step and a membrane area of 387 m² is needed for the second membrane separation step.

### Example 6

### Two-Step Process not in Accordance with the Invention, Using Membranes of Higher Selectivity for the First Membrane Separation Step and Lower Selectivity for the Second Membrane Separation Step

The calculation of Example 3 was repeated, this time using a higher selectivity of 200 for the first membrane separation step and a membrane of lower selectivity of 20 for the second membrane separation step. Other parameters were the same as in Example 3. The results of the calculation are shown in Table 4.

TABLE 4

| Stream | 21 | 26 | 27 | 31 | 32 |
|---|---|---|---|---|---|
| Total flow (kg/h) | 1,000 | 72.0 | 928 | 116 | 812 |
| Component A con- | 16.0 | 91.0 | 3.3 | 19.0 | 0.76 |
| centration (vol %) | | | | | |
| Temperature (° C.) | 110 | 33 | 109 | 24 | 109 |
| Pressure (bara) | 3 | 0.1 | 3 | 0.1 | 3 |

The process was again configured to obtain a first residue/second feed concentration of the limiting concentration of 3.3 vol %. On this basis, a membrane area of 194 m² is needed for the first membrane separation step and a membrane area of 134 m² is needed for the second membrane separation step.

### Example 7

### Two-Step Process not in Accordance with the Invention, Using Membranes of Lower Selectivity for the First Membrane Separation Step and Higher Selectivity for the Second Membrane Separation Step, and with Recycle of the Second Permeate Stream within the Process

A calculation was performed to a two-step process in accordance with the flow scheme of FIG. 4, but using a membrane with a lower selectivity of 20 for the first membrane separation step and a membrane of higher selectivity of 200 for the second membrane separation step.

As with the previous examples, the permeance of the membranes for component A was assumed to be 1,000 gpu and the pressure ratio was set to 30 (3 bar feed, 0.1 bar permeate). The results of the calculations are shown in Table 5.

TABLE 5

| | Stream | | | | |
|---|---|---|---|---|---|
| | | | | 8 | |
| | 1 | 4 | 5 | (recycle) | 11 |
| Total flow (kg/h) | 1,000 | 181 | 860 | 40.8 | 819 |
| Component A con- | 16.0 | 60.1 | 3.3 | 41.5 | 0.76 |
| centration (vol %) | | | | | |
| Temperature (° C.) | 110 | 29 | 109 | 29 | 109 |
| Pressure (bara) | 3 | 0.1 | 3 | 0.1 | 3 |

The process was again configured to obtain a first residue/second feed concentration of the limiting concentration of 3.3 vol %. On this basis, a membrane area of 152 m² is needed for the first membrane separation step and a membrane area of 400 m² is needed for the second membrane separation step.

### Example 8

### Two-Step Process in Accordance with the Invention of FIG. 4

A calculation was performed to model the process of the invention in accordance with FIG. 4, using a membrane with a higher selectivity of 200 for the first membrane separation step and a membrane of lower selectivity of 20 for the second membrane separation step.

As with the previous examples, the permeance of the membranes for component A was assumed to be 1,000 gpu and the pressure ratio was set to 30 (3 bar feed, 0.1 bar permeate). The results of the calculations are shown in Table 6.

TABLE 6

| | Stream | | | | |
|---|---|---|---|---|---|
| | | | | 8 | |
| | 1 | 4 | 5 | (recycle) | 11 |
| Total flow (kg/h) | 1,000 | 83.5 | 1.047 | 131 | 916 |
| Component A con- | 16.0 | 91.0 | 3.3 | 19.0 | 0.76 |
| centration (vol %) | | | | | |
| Temperature (° C.) | 110 | 33 | 109 | 29 | 109 |
| Pressure (bara) | 3 | 0.1 | 3 | 0.1 | 3 |

The process was yet again configured to obtain a first residue/second feed concentration of the limiting concentration of 3.3 vol %. On this basis, a membrane area of 220 m² is needed for the first membrane separation step and a membrane area of 150 m² is needed for the second membrane separation step.

### Example 9

### Comparison of Examples 3-8

The performance of the process of the invention according to Example 8 was compared with the performance of the processes of Examples 3-7, with respect to both the concentration of component A in the first permeate stream and the membrane area required to perform the separation. The comparison is summarized in Table 7.

TABLE 7

| | Example number | | | | | |
|---|---|---|---|---|---|---|
| | 3 | 4 | 5 | 6 | 7 | 8 |
| Concentration A in first | 90.8 | 58.5 | 58.6 | 91.0 | 60.1 | 91.0 |
| permeate (vol %) | | | | | | |
| Membrane area for first | 195 | 140 | 140 | 194 | 152 | 220 |
| membrane separation step | | | | | | |
| (m²) | | | | | | |
| Membrane area for second | 430 | 120 | 387 | 134 | 400 | 150 |
| membrane separation | | | | | | |
| step (m²) | | | | | | |
| Total membrane area (m²) | 625 | 260 | 527 | 328 | 552 | 370 |

All of the examples achieved reduction of component A to below 1 vol % in the second residues stream. As can be seen, the process of the invention (Example 8) achieved as good concentration of component A in the first permeate stream as the process using a high selectivity membrane in both steps, but did so with the use of only 60% as much membrane area (370 m² as opposed to 625 m²).

### Example 10

### Two-Step Process in Accordance with the Invention of FIG. 5

A calculation was performed to model the process of the invention in accordance with FIG. 5. The assumptions were substantially the same as for Example 8, except that the process was assumed to be carried out by running the raw mixture first through a rectification column operating at 0.5 bara pressure. The results of the calculation are shown in Table 8.

TABLE 8

| Stream | 20 | 18 | 1 | 4 | 5 | 8 | 11 |
|---|---|---|---|---|---|---|---|
| Total flow | 1,774 | 885 | 1,094 | 78.7 | 1,016 | 127 | 889 |
| (kg/h) | | | | | | | |
| Component | 71.9 | 99.9 | 16.0 | 90.8 | 3.3 | 19.1 | 0.76 |
| A | | | | | | | |
| concentra- | | | | | | | |
| tion (vol %) | | | | | | | |
| Temperature | 92 | 99.5 | 111 | 111 | 111 | 110 | 109 |
| (° C.) | | | | | | | |
| Pressure | 1 | 0.5 | 3 | 0.1 | 3 | 0.1 | 3 |
| (bara) | | | | | | | |

As can be seen, the process of the invention produces a second residue product stream in which the concentration of component A has been reduced to below 1 vol %. A liquid stream of essentially pure component A is withdrawn as a bottoms stream from the column. The process uses 211 m² of membrane for the first membrane separation step and 146 m² for the second step.

1. A process for separating a gas mixture comprising vapors of condensable components A and B, comprising:
(a) passing the gas mixture to a first membrane separation step equipped with first membranes of selectivity α₁ for component A over component B;
(b) maintaining a first driving force for transmembrane permeation in the first membrane separation step, thereby producing a first residue stream depleted in component A compared with the gas mixture and a first permeate stream enriched in component A compared with the gas mixture;
(c) passing the first residue stream to a second membrane separation step equipped with second separation membranes of selectivity α₂ for component A over component B, where α₁ and α₂ satisfy the relationship α₁>α₂;
(d) maintaining a second driving force for transmembrane permeation in the second membrane separation step, thereby producing a second residue stream further depleted in component A compared with the gas mixture and a second permeate stream; and
(e) returning at least a portion of the second permeate stream for further separation treatment within the process.

2. The process of claim 1, wherein the first membrane separation step operates at a first pressure ratio θ₁ and the second membrane separation step operates at a second pressure ratio θ₂ and both pressure ratios are less than 50.

3. The process of claim 2, wherein both pressure ratios are in the range 20-50.

4. The process of claim 1, wherein the second driving force is created at least in part by cooling the second permeate stream, causing at least a portion of the second permeate stream to condense.

5. The process of claim 1, wherein the first residue stream has a concentration of component A that is below 130% of the limiting concentration.

6. The process of claim 1, wherein the first residue stream has a concentration of component A that is above 70% of the limiting concentration.

7. The process of claim 1, wherein the first residue stream has a concentration of component A that is below 115% of the limiting concentration.

8. The process of claim 1, wherein the first residue stream has a concentration of component A that is above 85% of the limiting concentration.

9. The process of claim 1, wherein α₁ and α₂ satisfy the relationship α₁/α₂≧3.

10. The process of claim 1, wherein component A is water.

11. The process of claim 1, wherein at least one of component A and component B is an organic vapor.

12. The process of claim 1, wherein component A is water and component B is ethanol.

13. The process of claim 1, wherein the second residue stream contains less than 2 vol % of component A.

14. The process of claim 1, wherein the second residue stream contains less than 1 vol % of component A.

15. A process for separating a gas mixture comprising vapors of condensable components A and B, comprising:
(a) providing a separation column adapted to provide a bottoms stream enriched in component A compared with the gas mixture and an overhead stream depleted in component A compared with the gas mixture;
(b) passing the gas mixture into the separation column;
(c) withdrawing the bottoms stream from the separation column;
(d) withdrawing the overhead stream from the separation column;
(e) passing at least a portion of the overhead stream to a first membrane separation step equipped with first membranes of selectivity α₁ for component A over component B;
(f) maintaining a first driving force for transmembrane permeation in the first membrane separation step, thereby producing a first residue stream depleted in component A compared with the overhead stream and a first permeate stream enriched in component A compared with the overhead stream;
(g) passing the first residue stream to a second membrane separation step equipped with second separation membranes of selectivity α₂ for component A over component B, where α₁ and α₂ satisfy the relationship α₁>α₂;
(h) maintaining a second driving force for transmembrane permeation in the second membrane separation step, thereby producing a second residue stream further depleted in component A compared with the overhead stream and a second permeate stream;
(i) returning at least a portion of the second permeate stream for further separation treatment within the separation column.

16. The process of claim 15, wherein the column is a distillation column.

17. The process of claim 15, wherein the column is a stripping column.

18. The process of claim 15, wherein the second driving force is created at least in part by cooling the second permeate stream, causing at least a portion of the second permeate stream to condense.

19. The process of claim 15, wherein the first residue stream has a concentration of component A that is below 130% of the limiting concentration.

20. The process of claim 15, wherein the first residue stream has a concentration of component A that is above 70% of the limiting concentration.

21. The process of claim 15, wherein the first residue stream has a concentration of component A that is below 115% of the limiting concentration.

22. The process of claim 15, wherein the first residue stream has a concentration of component A that is above 85% of the limiting concentration.

23. The process of claim 15, wherein α₁ and α₂ satisfy the relationship α₁/α₂≧3.

24. The process of claim 15, wherein component A is water.

25. The process of claim 15, wherein component A is water and component B is ethanol.

26. The process of claim 15, wherein the second residue stream contains less than 2 vol % of component A.

27. The process of claim 15, wherein the second residue stream contains less than 1 vol % of component A.

28. The process of claim 1, wherein the second membrane separation step is predominately pressure-ratio-limited.

29. The process of claim 15, wherein the second membrane separation step is predominately pressure-ratio-limited.
